(19) United States
(12) Patent Application Publication
(10) Pub. No.: US 2020/0147688 A1
(43) Pub. Date: May 14, 2020

(54) METHOD FOR PRODUCING A PART FROM A SOFT MAGNETIC ALLOY

(71) Applicant: Vacuumschmelze GmbH & Co. KG, Hanau (DE)

(72) Inventors: Johannes TENBRINK, Mombris (DE); Niklas VOLBERS, Bruchkobel (DE); Jan Frederik FOHR, Rodermark (DE)

(21) Appl. No.: 16/676,149

(22) Filed: Nov. 6, 2019

(30) Foreign Application Priority Data
Nov. 8, 2018 (DE) 10 2018 127 918.3

(51) Int. Cl. B22F 3/105; B22F 9/08; B22F 3/10; C22C 38/10; C22C 38/06; B33Y 10/00; B33Y 80/00; B33Y 70/00; H01F 1/147

(52) U.S. Cl. CPC B22F 3/1055; B22F 9/082; B22F 3/1007; C22C 38/10; C22C 38/06; C22C 2202/02; B33Y 80/00; B33Y 70/00; H01F 1/14791; H01F 1/147; B22F 2301/35; B33Y 10/00

(57) ABSTRACT

A method is provided for producing a part from a soft magnetic alloyis provided. The method includes producing a powder from a feedstock made of a soft magnetic alloy by means of atomisation. The method further includes producing a part made of the powder by means of an additive manufacturing process in a protective atmosphere with an oxygen content of less than 100 ppmv, preferably below 50 ppmv, particularly preferably below 10 ppmv, the powder being at least partially melted. The part has a density of greater than 98%, an oxygen content of less than 500 ppmw, a sulphur content of less than 200 ppmw, a carbon content of less than 500 ppmw and a nitrogen content of less than 200 ppmw The part has a coercive field strength of less than 5 A/cm following a subsequent heat treatment.

This U.S. patent application claim priority to German application no. 10 2018 127 918.3, filed Nov. 8, 2018, the entire contents of which is incorporated herein by reference.

### BACKGROUND

### 1. Field of Invention

The present invention relates to a method for producing a part from a soft magnetic alloy.

### 2. Related Art

Soft magnetic materials are used in various applications, e.g. in the stators and rotors of electric machines such as motors and generators, for example.

In use in an electric machine the magnetic flux is carried in the soft magnetic material of the stator or rotor. Generally speaking, the higher the flux density in the material at a given field strength, the less material is required and the higher the torque that can be achieved.

The soft magnetic material may take the form of laminations cut from a soft magnetic alloy and stacked one on top of another to form a laminated core. Non-grain-oriented electrical steel sheet with approx. 3 wt % silicon (SiFe) is the most common crystalline soft magnetic material used in laminated cores in electric machines. GB 2550593 A discloses a laminated core comprising sheets of different alloys that each have different magnetic properties in order to adjust the magnetic properties of a laminated core.

EP 1 051 714 B2 discloses a soft magnetic iron-nickel alloy that can be produced using steel mill technology. The iron-nickel alloy may, for example, be used for relay parts such as armatures and yokes, solenoid valve covers and cups, yokes and pole pieces, shoes, plates and armatures for retaining and electromagnets, stepper motor coil formers and stators and rotors and stators in electric motors, moulded and stamped sensor parts, magnetic heads and magnetic head shields, shielding devices e.g. engine shields, shielding cups for display instruments and shields for cathode ray tubes.

Further improvements are, however, desirable in order to provide parts and semi-finished products such as yokes and armatures for relays, flow conductors or cup systems with good mechanical and soft magnetic properties.

### SUMMARY

The object is achieved by means of a method in which a powder is produced from a feedstock made of a soft magnetic alloy by means of atomisation and a part or semi-finished product is produced from the powder by means of an additive manufacturing process in a protective atmosphere with an oxygen content of less than 100 ppmv, preferably below 50 ppmv, particularly preferably below 10 ppmv, the powder being at least partially melted. The part has a crystalline structure; a density greater than 98%, preferably greater than 99,5%, preferably greater than 99,8%; an oxygen content of less than 500 ppmw, preferably less than 200 ppmw, less than 100 ppmw or less than 50 ppmw; a sulphur content of less than 200 ppmw, preferably less than 100 ppmw, or less than 50 ppmw; a carbon content of less than 500 ppmw, preferably less than 200 ppmw, or less than 100 ppmw; and a nitrogen content of less than 200 ppmw, preferably less than 100 ppmw, or less than 50 ppmw.

In some embodiments, the part has a density of greater than 98%, an oxygen content of less than 500 ppmw, a sulphur content of less than 200 ppmw, a carbon content of less than 500 ppmw and a nitrogen content of less than 200 ppmw, and, following a subsequent heat treatment, has a coercive field strength of less than 5 A/cm.

Using this method it is possible to produce complex three-dimensional structures that can be made using machining techniques only at high manufacturing costs, if the structure can be made using machining techniques at all, from a soft magnetic alloy. In addition, it is possible to produce soft magnetic parts with complex geometric forms from alloys that are difficult to bend or respond poorly to bending and even from alloys that are so difficult to machine and in some cases so brittle that machining and line production are completely impossible.

Similarly, it is possible using the manufacturing process according to the invention to produce both laminate-type parts and also parts with three-dimensional structures including those with complex geometrical forms from alloys that due to their brittleness are difficult if not impossible to make in strip form.

The additive manufacturing process is carried out in an atmosphere with a very low oxygen content, thereby making it possible to use this type of manufacturing process for additional alloys, e.g. iron-aluminium alloys.

As the additive manufacturing process is carried out in a protective atmosphere with a low oxygen content of no more than 100 ppmv, it is very largely possible to avoid the formation of oxide inclusions in the additively manufactured part and to improve its magnetic properties. In particular, oxide inclusions impair the soft magnetic properties, i.e. coercive field strength increases and permeability decreases. As a consequence, it is possible using the method according to the invention to produce parts with a low coercive field strength of less than 5 A/cm, for example.

The protective atmosphere may be an inert atmosphere produced with an inert gas such as argon, nitrogen or helium, or a reducing atmosphere containing a percentage of, e.g. H₂ in addition to an inert gas.

In an additive manufacturing process the part is built up layer by layer by repeating the following steps: applying a layer made of the powder and selectively melting the layer using a three-dimensionally controllable energy beam. The energy beam is steered three-dimensionally across the powder layer according to a three-dimensional CAD file of the part to produce a layer of the part. The powder may, for example, be selectively melted using a laser beam or electron beam.

In one embodiment, using selective laser melting, the material to be processed, i.e. the desired soft magnetic alloy, is applied to a base plate in powder form in a thin layer. The powder material is completely remelted locally using laser irradiation and, after solidification, forms a solid layer of material. Then powder is again applied once more. This cycle is repeated until all the layers have been remelted. The finished part is cleaned of surplus powder and then further worked as required or used immediately. To improve the soft magnetic properties it can be subjected to final annealing in an inert gas, a vacuum or preferably in a protective gas atmosphere containing H₂, particularly preferably in the driest possible H₂. The layer thicknesses typical for building up the part range from 15 μm to 500 μm for all materials. To avoid oxygen contamination of the material, the process takes place in a protective gas atmosphere containing argon or nitrogen. The protective gas atmosphere may also contain hydrogen.

The data used to guide the laser beam is generated by a software programme from a three-dimensional CAD body. In the first calculation step, the part to be produced is divided into individual layers. In the second calculation step, tracks (vectors) are generated for each layer along which the laser beam then passes.

Parts manufactured using selective laser melting are characterised by high specific densities that reach almost 100% of the theoretical density. This guarantees that the mechanical properties of the generatively produced part corresponds to that of the basic material.

By means of the atomisation process, the powder is provided with spherical particles of even size. Spherical particles provide good powder flowability. This increases the density of the powder bed from which the part is built up layer by layer using the additive manufacturing process, thereby achieving an even higher density in the finished part. As a result, parts with both good mechanical and good magnetic properties are achieved.

For example, the feedstock may be atomised in inert gas in such a manner that the chemical composition remains practically unaltered during the atomisation process and the powder contains a low degree of C, S, N and O impurities. Optionally, the feedstock can be subjected to a cleaning heat treatment in a reducing atmosphere such as hydrogen, for example, before gas atomisation. To prevent an agglomeration of powder particles, the powder is preferably not magnetised.

The atomisation process used may be gas atomisation in an inert gas such as argon, nitrogen or helium. The starting material is melted in an air bell or a protective gas bell or in a vacuum. The chamber is then filled with gas to drive the molten alloy through the nozzle where a gas flow hits the flowing molten mass at high speed and breaks it up. The powder consists predominantly of spherical particles.

Alternatively, the powder can be produced by means of EIGA (Electrode Induction Melting Gas Atomisation), centrifugal atomisation or plasma moulding. In one embodiment the powder has an average particle size of 10 μm to 80 μm.

The method according to the invention can be used to produce parts from a crystalline soft magnetic alloy for various applications. For example, the part make take the form of a yoke for relay applications or an armature for relay applications, of a flow conductor, a part for electromagnetic lenses, an armature for injection technology or a cup system for injection technology, e.g. for injectors for petrol, diesel, LNG and other liquids or gases, a part for an electromechanical actuator, a lamination for a stator or rotor in a motor, generator or other electric machine, a part for a sensor system or a part for a torque sensor.

The low oxygen content in the space can be provided by various different methods. In one embodiment the part is produced by means of an additive manufacturing process in a closed production space. The production space may contain a protective atmosphere that may, for example, be an inert atmosphere provided by means of an inert gas such as argon, nitrogen or helium, or a reducing atmosphere that may contain H₂, for example.

The space is rinsed with inert gas to adjust the oxygen content. The space can also be alternately pumped out and rinsed during the production process. The inert gas may comprise argon, nitrogen or helium.

In some embodiments the atmosphere in the space also contains H₂. A protective gas atmosphere of this type contains a mixture of an inert gas, such as argon, nitrogen or helium, and H₂. The percentage of H₂ is set so as to prevent any risk of explosion.

The risk of explosion depends on the percentage of oxygen in the atmosphere, the temperature and the pressure. For example, there is a risk of explosion in the air at a H₂ content of 4% to 77%. As a result, the H₂ percentage is set so as to be below or above this range.

In one embodiment the part is produced by means of an additive manufacturing process in a vacuum with an oxygen pressure of below 0.1 mbar, preferably below 0.05 mbar, particularly preferably below 0.01 mbar.

The feedstock may consist of single elements or of an alloy. In one embodiment a precursor made from the feedstock is melted and the molten mass is processed to form a powder by means of atomisation. In a further embodiment a precursor from of the feedstock is melted and solidified before being melted again and processed to form a powder by means of atomisation.

Once the part has been built up layer by layer using the additive manufacturing process, the part may already have a crystalline texture or a crystalline structure.

Once the part has been built up layer by layer using the additive manufacturing process, the part can also be heat treated, for example at 600° C. to 1,400° C. for at least 0.25 h, preferably 2 h to 10 h. This heat treatment may take place in an inert atmosphere. In one embodiment this heat treatment take place in a reducing atmosphere, for example one that contains an NH₃ cracked gas or a mixture of H₂ with N₂ and/or Ar and preferably has a saturation temperature of below −20° C. In one embodiment the heat treatment takes place in a vacuum at a pressure of less than 0.1 mbar.

Following this heat treatment, the part has a crystalline structure. This heat treatment can be used to improve the purity of the part, e.g. to further reduce the oxygen content, sulphur content, carbon content and nitrogen content and/or to improve the magnetic properties and/or create the crystalline structure. This heat treatment also promotes grain growth in order to improve the soft magnetic properties, for example to lower the coercive field strength H_{c} and raise the permeability level.

In one embodiment, following heat treatment, the part has an oxygen content of less than 500 ppmw, preferably below 200 ppmw, particularly preferably below 100 ppmw, more particularly preferably below 50 ppmw; a sulphur content of less than 100 ppmw, preferably below 50 ppmw, particularly preferably below 20 ppmw; a carbon content of less than 200 ppmw, preferably below 200 ppmw, particularly preferably below 60 ppmw; and a nitrogen content of less than 100 ppmw, preferably below 50 ppmw, particularly preferably below 20 ppmw.

In one embodiment, following heat treatment, the part has a coercive field strength H_{c} of less than 5 A/cm, preferably less than 2 A/cm, preferably less than 1 A/cm.

The method according to the invention broadens the field of application of soft magnetic alloys, in particular soft magnetic alloys that cannot be produced reliably using deformation and/or machining methods.

In one embodiment the soft magnetic alloy is an FeSi alloy with approx. 3 wt % Si. Alloys of this type are frequently referred to as electrical steel. Electrical steel with approx. 3 wt % silicon (SiFe) is the commonest crystalline soft magnetic material and is used first and foremost in electric machines. The addition of Si to pure iron causes an increase in electrical resistance, a reduction in magnetostriction and a small drop in magnetocrystalline anisotropy. In addition, from approx. 2 wt % Si the austenitic phase of the iron is suppressed at high temperatures so that only the purely ferritic stage is present up to the melting point. As a result, the alloy can be heat treated at high temperatures without going through a phase transition that damages the microstructure.

To adjust the magnetic and mechanical properties it is possible to carry out final heat treatment. The heat treatment takes place at temperatures of 600° C. to 1400° C. in a reducing atmosphere containing hydrogen, in an inert gas or in a vacuum.

In one embodiment, in addition to iron and unavoidable impurities, the soft magnetic FeSi alloy consists of 2 wt %≤Si+Al≤4 wt % and 0 wt %≤Mn+C+S+Se+N+Ti+P+As+Sn+Sb+Te+Bi+Cu+Ni+Mo+Cr+Co+B+V+Nb+O≤1.0 wt %, preferably 0.5 wt %. The sum of Si and Al lies between 2 wt % and 4 wt %. The alloy may contain up to 1 wt % of one or more of the elements from the group consisting of Mn+C+S+Se+N+Ti+P+As+Sn+Sb+Te+Bi+Cu+Ni+Mo+Cr+Co+B+V+Nb+O.

In one embodiment the soft magnetic alloy is an FeSi alloy with approx. 6.5 wt % Si. These alloys have a zero crossing of the saturation magnetostriction constant λₛ, resulting in very good soft magnetic properties. In addition, the high Si content compared to non-grain-oriented alloys of 3 wt % Si results in a clearly higher electrical resistance of approx. 0.82 μΩm. At approx. 1.8 T the saturation magnetisation is lower than that of Fe-3% Si alloys at approx. 2 T. From approx. 4 wt % Si in Fe the alloy becomes brittle and can no longer be cold rolled. The higher Si contents are generally achieved by depositing silicon from the vapour phase onto the material and then diffusing it into the material in a subsequent diffusion annealing process.

To set the lowest possible Si gradients from the surface to the middle of the material, the material thicknesses are capped due to the final diffusion length and typically fluctuate in the region of 0.1 mm. With the additive manufacturing process according to the invention it is possible to make parts out of this alloy and to achieve higher material thicknesses.

In one embodiment the soft magnetic alloy consists 4 wt %≤Si+Al≤8 wt % and 0 wt %≤Mn+C+S+Se+N+Ti+P+As+Sn+Sb+Te+Bi+Cu+Ni+Cr+Co+B+V+Nb+N+O≤1.0 wt %, preferably 0.5 wt %, in addition to iron and unavoidable impurities.

In one embodiment the soft magnetic alloy is an FeSiAl alloy, for example with a typical composition of 9 wt % Si, 6 wt % Al and the balance Fe. Due to a zero crossing of the magnetocrystalline anisotropy constant K₁ and the saturation magnetostriction constant λₛ, these alloys have low coercive field strengths H_{c} typically below 10 A/m and maximum permeabilities typically above 100,000. However, these alloys are brittle due to adjustments in order. Parts made of this alloy are conventionally processed to form a powder using powder metallurgy techniques and then sintered. The sintered parts may be subjected to final heat treatment to set their magnetic properties. The sintering process precludes 100% density due to the formation of pores between the sinter grains. Parts can be made of these alloys despite their brittleness. The method according to the invention melts the material and so also creates a metallurgically bonded density of almost 100%. In one embodiment the soft magnetic alloy consists of 5 wt % to 12 wt % Si, 2 wt % to 10 wt % Al, up to 0.5 wt %, preferably 0.1 wt % impurities and the balance Fe.

In one embodiment the soft magnetic alloy is an FeCo alloy with a composition of 5 wt % to 30 wt % Co and the balance iron. These alloys have a high saturation induction and good deformability because no embrittling order adjustment is perceivable until approx. 30 wt % Co. Further elements such as V, Cr, Si, Mn, Al, Ta, Ni, Mo, Cu, Nb, Ti and Zr can be added to increase electrical resistance or improve mechanical properties. In addition, elements such as calcium, beryllium and/or magnesium can be added in small amounts of up to 0.05 wt % for the purpose of deoxidation and sulphur removal.

For these alloys, a melt or molten mass is conventionally provided by means of vacuum induction melting, electroslag remelting or vacuum arc remelting. The melt is solidified to form an ingot and the ingot is reshaped to form a primary product with final dimensions, this reshaping being carried out by means of hot rolling and/or forging and/or cold working. Intermediate annealing to intermediate dimensions can be carried out in a continuous furnace or a stationary furnace in a dry or damp atmosphere containing hydrogen or in an inert gas in order to decarbonise the material or to achieve a desired degree of cold deformation or texture.

To adjust the magnetic and mechanical properties the alloys are subjected to a final heat treatment. The heat treatment takes place at a temperature of 600° C. to 1400° C. in an atmosphere containing hydrogen, in an inert gas or in a vacuum. The alloys are used primarily as flow pieces or electromagnetic actor materials in solenoid valves, for example. Unlike the Fe—Co alloys with Co contents of greater than approx. 30 wt %, no embrittling order adjustment takes place in alloys below approx. 30 wt % and they can therefore once again be deformed to a certain extent in the re-cooled state.

In one embodiment the soft magnetic alloy consists of 5 wt % to 30 wt % Co, 0 wt %≤V+Cr+Si+Mn+Al+Ta+Ni+Mo+Cu+Nb+Ti+Zr≤10 wt %, up to 0.2 wt %, preferably 0.05 wt % impurities and the balance Fe. The impurities may, for example, include C, S, N, O, B, P, N, W, Hf, Y, Re, Sc and other lanthanoids.

In one embodiment the soft magnetic alloy is an FeCo alloy with 30 wt % to 55 wt % Co. CoFe alloys with a typical composition of 49 wt % Fe, 49 wt % Co and 2% V have a saturation induction of approx. 2.35 T at a simultaneously high electrical resistance of 0.4 μΩm. Electric machines built up with these alloy therefore have a higher power density and lower losses. Further elements V, Cr, Si, Mn, Al, Ta, Ni, Mo, Cu, Nb, Ti and Zr can also be added to increase electrical resistance and improve mechanical properties. At temperatures around approx. 730° C. an order transition from an unordered distribution of the atoms in the crystal lattice to an ordered superstructure takes place.

A molten mass is conventionally provided by means of vacuum induction melting, electroslag remelting or vacuum arc remelting, for example. The molten mass is solidified to form an ingot and the ingot is reshaped to form a primary product with final dimensions, this reshaping being carried out by means of hot rolling and/or forging and/or cold working. Intermediate annealing to intermediate dimensions can be carried out in a continuous furnace or a stationary furnace in a dry or damp atmosphere containing hydrogen or in an inert gas in order to decarbonise the material or to achieve a desired degree of cold deformation or texture.

To adjust the magnetic and mechanical properties the alloys are subjected to a final heat treatment. The heat treatment takes place at a temperature of 600° C. to 1400° C. in an atmosphere containing hydrogen, in an inert gas or in a vacuum. If the primary material is produced using this conventional manufacturing route the order transition causes the material to become brittle in the cooled state such that it is impossible to carry out subsequent forming by means of bending, stamping or stamping/bending without introducing defects into the material.

Consequently, an additive manufacturing process can be used to produce the part with the desired final or almost final shape in order to avoid the restrictions caused by embrittling.

In one embodiment the soft magnetic alloy consists of 30 wt % to 55 wt % Co, 0 wt %≤V+Cr+Si+Mn+Al+Ta+Ni+Mo+Cu+Nb+Ti+Zr≤5 wt %, up to 0.2 wt %, preferably 0.05 wt % impurities and the balance Fe. The impurities can include, for example, C, S, N, O, B, P, N, W, Hf, Y, Re, Sc and other lanthanoids.

In one embodiment the soft magnetic alloy is an FeAl alloy with up to 20 wt % Al. Soft magnetic alloys with a composition of 5 to 20 wt % Al and the balance Fe have a considerably higher electrical resistance than pure iron. At 12 wt % Al and 16 wt % Al there are zero crossings of magnetocrystalline anisotropy constant K1 and in this case it is therefore possible to set very low coercive field strengths of below 10 A/m in the final annealed state. The final annealing takes place in a vacuum, protective gas or a reducing atmosphere (e.g. hydrogen). As the alpha-gamma phase transition is already suppressed at wt % Al, annealing can be carried out in a wide temperature range of 600° C. to 1400° C. At 16 to 18 wt % Al it is possible—as for the binary 30% NiFe alloys—to tailor the Curie temperature using the Al content. Fe—Al alloys have a considerably higher hardness than Fe.

Due to the order adjustment (DO3 superstructure) and the tendency to coarse grain formation in alloys with at least 5 wt % Al, processing using hot rolling and cold rolling is possible either in only very limited cases or not at all. With the additive method according to the invention, on the other hand, these manufacturing restrictions do not apply.

In one embodiment the iron-aluminium alloy consists of 5 wt % to 20 wt % Al, 0≤Mn+C+S+Se+N+Ti+P+As+Sn+Sb+Te+Bi+Cu+Ni+Cr+Co+B+V+Nb+N+O+Si≤3 wt %, up to 0.2 wt % impurities and the balance Fe.

As binary iron-aluminium alloys, parts made of one of the following compositions can be produced using the method according to the invention.

The addition of 3% Al provides an alternative to 3% SiFe. The resistance and the magnetic properties are of a similar level. Due to the high affinity to oxygen this type of alloy can only be melted if oxygen is excluded.

The addition of 8% Al results in a relatively high saturation of 1.7 T at a very good resistance of 80μ·Ohm·cm. Despite the high level of crystalline anisotropy present it would be possible—in the same way as for pure iron—to set a high grain size by providing adequate material purity and a high annealing temperature, and to achieve a low Hc. An alloy of this type is suitable for use in fast rotating electric machines.

The addition of 12% Al produces a material with a high permeability as here there is a zero crossing of the crystalline anisotropy K1 in the final annealed, i.e. ordered state. At 1.4 T, saturation is already lower, but remains comparable to that of a binary 40% NiFe alloy. The very high electrical resistance in the region of 100 μΩcm is advantageous.

The addition of 16% Al produces a zero crossing of K1 in both the ordered and the unordered states. As a result, it is considerably easier to set the vanishing anisotropy than is the case with 12% Al. An alloy of this type used to be available under the name VACODUR 16. It was used primarily in wear-resistant recording heads.

The addition of between 16 and 18% Al causes the Curie temperature of the material to drop sharply, i.e. specific Curie temperatures can be set by selecting the Al content. It therefore represents an alternative to the binary 30% NiFe alloys.

In one embodiment the soft magnetic alloy is a ternary FeCoAl alloy with up to 7 wt % Al. Soft magnetic alloys with a composition of 5 to 60 wt % Co and up to 5 wt % Al have higher saturation induction than purely binary Fe—Al alloys. At Al contents of above 5 wt %, on the other hand, the addition of Co results in a decrease in saturation. Compared to the purely binary Fe—Co alloy, in the Fe—Co—Al system the alpha-gamma phase transition is pushed upwards or suppressed, thereby resulting in a higher Curie temperature. In addition, with this type of ternary alloy the final annealing can be carried out at higher temperatures than in the binary Fe—Co system. Overall, this results in relatively low coercive field strengths H_{c}.

As is also the case with the binary Fe—Al alloys, the addition of Al significantly reduces deformability. While alloys with 3 wt % Al and up to 20 wt % Co can still be rolled easily, an alloy with 5 wt % Al and 10 wt % or more Co is very difficult or impossible to roll. The brittleness can result in transverse cracks or splits in the strip, for example. The method according to the invention therefore permits a production of parts that would not have been possible using the conventional manufacturing route.

In one embodiment the iron-cobalt-aluminium alloy consists of 5 wt % to 60 wt % Co, 0.5 wt % to 5 wt % Al, 0≤Mn+C+S+Se+N+Ti+P+As+Sn+Sb+Te+Bi+Cu+Ni+Cr+Co+B+V+Nb+N+O+Si≤3 wt %, up to 0.2 wt % impurities and the balance Fe.

### BRIEF DESCRIPTION OF THE DRAWINGS

Embodiments will be now be explained in greater detail with reference to the drawings.

FIG. 1 shows a schematic representation of an arrangement for producing a powder by means of an atomisation process.

FIG. 2 shows a schematic representation of a system for producing a part by means of an additive manufacturing process.

FIG. 3 shows an enlarged view of the layered arrangement of a part from a soft magnetic alloy.

### DETAILED DESCRIPTION OF EXAMPLE EMBODIMENTS

According to the invention, a soft magnetic crystalline part or semi-finished product is produced by means of an additive manufacturing process. A powder is used as the feedstock or starting material, this powder consisting of individual elements of the soft magnetic alloy or of pre-alloyed material. According to the invention, the powder is produced by means of an atomisation process such that the powder comprises spherical particles and has high flowability. These spherical particles serve to increase the density of the finished soft magnetic part.

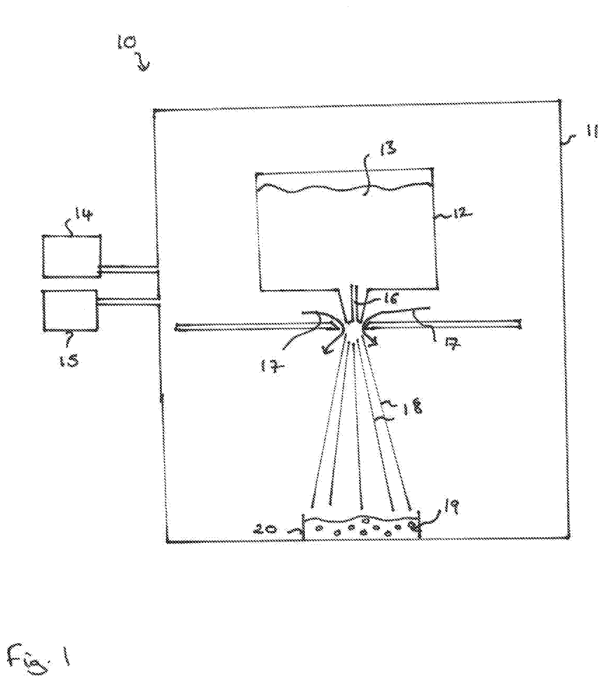

FIG. 1 shows a schematic representation of an arrangement 10 for producing a powder by means of an atomisation process. In this embodiment a gas atomisation process with an inert gas is used.

The arrangement 10 has a closed chamber 11 in which is arranged a container 12 for a molten mass or melt 13 of the feedstock made of the soft magnetic alloy. A gas source 14 and a pump 15 are coupled to the chamber 11 such that the chamber 11 can be supplied with a gas, in particular an inert gas or a vacuum. The melt 13 is driven through a nozzle 16, a gas flow at a higher speed represented schematically by the arrows 17, hitting the melt 13 and breaking it up into particles 18. The resulting powder 19 consists predominantly of spherical particles that are collected in a collecting vessel 20. The powder 19 may have an average particle size of 10 μm to 80 μm.

This powder 19 is used as the feedstock or starting material in an additive manufacturing process in order to produce a soft magnetic part.

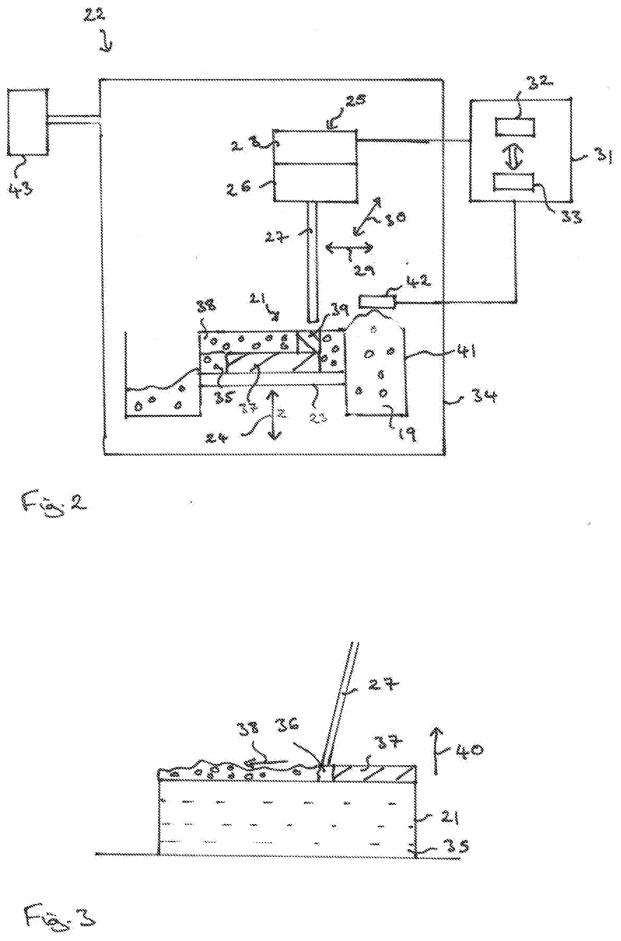

FIG. 2 shows a schematic representation of a system for producing a soft magnetic part 21 using an additive manufacturing process. The additive manufacturing process illustrated uses selective laser-beam melting.

The system 22 has a base plate 23 on which the part 21 is built up layer by layer. The base plate 23 can be moved in the vertical or z direction to change the height of the base plate, as represented schematically by the arrow 24 in FIG. 2. The system 22 also has a laser source 25 for generating a laser beam 27, a focussing unit 26 and a control unit 28 by means of which the laser beam 27 can be controlled in the horizontal or lateral directions and in the x and y directions. The x and y directions are represented schematically by the arrows 29, 30 in FIG. 2. The control unit 28 and the focussing unit 26 are controlled by means of a control unit 31 comprising a processor unit 32 and a memory 33, which contains the files or data of the part 21 to be manufactured.

According to the invention, the additive manufacturing process takes place in a closed chamber 34 that is equipped and sealed to guarantee a very low oxygen content around the part 21. In particular, the additive manufacturing process takes place in an inert atmosphere or a reducing atmosphere with an oxygen content of less than 100 ppmv, preferably below 50 ppmv, particularly preferably below 10 ppmv. The system 10 may have a pump and gas unit 43 for adjusting the atmosphere and the oxygen content.

FIG. 3 shows an enlarged view of the layered arrangement of the part 21. The powder 19 is used as the feedstock. A first layer 35 consisting of the powder 19 is applied to the base plate 23 and selectively melted using the laser beam 27, once the laser beam 27 has moved away from the molten region 36 in the direction of arrow 38 this region 36 being re-solidified in order to generate a layer 37 of the part 21. The laser beam 27 is moved continuously across the first powder layer 35 in the x and/or y direction to ensure that three-dimensionally continuous melting and solidifying of the first layer 35 takes place in order to generate a layer 37 of the part 21 with a high density.

A further layer 38 of the powder 19 is applied by the source 41 to the first layer 37, for example by means of a blade 42 controlled by the control unit 31. The powder layer 38 is melted selectively and locally by the laser beam 27 and the laser beam moves continuously over the powder layer 38, thereby solidifying the molten region in order to generate a solid second layer 39 of the part 21. The part 21 is built up layer by layer in the direction of arrow 40 by repeating these steps.

The soft magnetic alloy may, for example, be an iron-aluminium alloy consisting of 5 wt % to 20 wt % Al, 0≤Mn+C+S+Se+N+Ti+P+As+Sn+Sb+Te+Bi+Cu+Ni+Cr+Co+B+V+Nb+N+O+Si≤3 wt % and up to 0.2 wt % of impurities. The part 21 may, for example, be a yoke for relay applications or an armature for relay applications, a flow conductor, a part for electromagnetic lenses, an armature for injection technology or a cup system for injection technology, a part for electromechanical actuators, a part for a sensor system, a part for a torque sensor, a lamination for stators and rotors in motors, generators or other electric machines.

According to the invention, the additive manufacturing process is carried out in an atmosphere with a very low oxygen content, e.g. less than 100 ppmv, such that immediately after production the part has an oxygen content of less than 500 ppmw. This low oxygen content can be guaranteed by sealing the chamber 31 in a specific manner by building up the part 21 layer by layer. Due to the low oxygen content during the additive manufacturing process the formation of oxide inclusions in the part 21 is very largely avoided. Consequently it is possible to produce parts with improved soft magnetic properties, e.g. with a low coercive field strength of less than 5 A/cm, using the method according to the invention.

Once the part 21 has been built up, the part 21 can then be heat treated. It is possible to set the magnetic properties during this heat treatment. The part can, for example, be heat treated at 600° C. to 1,400° C. for at least 0.25 h, preferably for 2 h to 10 h.

The heat treatment can be carried out in an inert atmosphere or in a vacuum at a pressure of less than 0.1 mbar. In some embodiments the heat treatment is carried out in a reducing atmosphere comprising an NH₃ cracked gas or a mixture of H₂ and N₂ and/or Ar. The heat treatment preferably takes place in pure H₂, particularly preferably in H₂ with a saturation temperature of <−20° C. Following heat treatment, the part 21 can have a still lower oxygen content, e.g. an oxygen content of less than 500 ppmw, preferably below 200 ppmw, particularly preferably below 100 ppmw, more particularly preferably below 50 ppm.

This heat treatment can be used to improve the purity of the part, e.g. to further reduce the oxygen content, the sulphur content, the carbon content or the nitrogen content and/or to improve the magnetic properties and/or to create the crystalline structure. This heat treatment also promotes grain growth in order to improve soft magnetic properties, e.g. to reduce the coercive field strength H_{c} and increase the permeability level.

1. A method for producing a part from a soft magnetic alloy, comprising:
producing a powder from a feedstock made of a soft magnetic alloy by means of atomisation,
producing a part from this powder by means of an additive manufacturing process in a protective atmosphere with an oxygen content of less than 100 ppmv, the powder being at least partially melted,
the part having
a crystalline structure,
a density greater than 98%, an oxygen content of less than 500 ppmw,
a sulphur content of less than 200 ppmw,
a carbon content of less than 500 ppmw, and
a nitrogen content of less than 200 ppmw.

2. A method according to claim 1, wherein gas atomisation, EIGA (Electrode Induction Melting Gas Atomisation), centrifugal atomisation or plasma moulding technology is used as the atomisation process.

3. A method according to claim 1, wherein the additive manufacturing process comprises laser-beam melting, laser-beam sintering, electron beam melting or electron beam sintering.

4. A method according to claim 1, wherein the part is produced by means of an additive manufacturing process in a closed space and this space is subject to inert gas rinsing.

5. A method according to claim 4, wherein the space is alternately pumped out and rinsed.

6. A method according to claim 1, wherein the inert gas comprises argon, nitrogen or helium.

7. A method according to claim 6, wherein the protective atmosphere further comprises H₂.

8. A method according to claim 1, wherein the part is produced by means of an additive manufacturing process in a vacuum at an oxygen pressure of below 0.1 mbar.

9. A method according to claim 1, wherein the feedstock consists of single elements or of an alloy.

10. A method according to claim 1, wherein a precursorof the feedstock is melted and the melt is processed to form a powder by means of atomisation.

11. A method according to claim 1, wherein a precursor of the feedstock is melted and solidified and subsequently melted again and processed to form a powder by means of atomisation.

12. A method according to claim 1, wherein the part is further heat treated at 600° C. to 1,400° C. for at least 0.25 h.

13. A method according to claim 12, wherein the heat treatment is carried out in a protective atmosphere.

14. A method according to claim 12, wherein the protective atmosphere is a reducing atmosphere comprising an NH₃ cracked gas, a mixture of H₂ with N₂ and/or Ar, or pure H₂, or the proctective atmosphere is an inert atmosphere.

15. A method according to claim 14, wherein the protective atmosphere further comprises H₂.

16. A method according to claim 12, wherein the heat treatment is carried out in a vacuum at a pressure of less than 0.1 mbar.

17. A method according to claim 12, following heat treatment the part has an oxygen content of less than 500 ppmw; a sulphur content of less than 100 ppmw; a carbon content of less than 200 ppmw; and a nitrogen content of less than 100 ppmw.

18. A method according to claim 12, wherein following the heat treatment the part has a coercive field strength H_{c} of less than 5 A/cm.

19. A method according to claim 1, wherein in addition to iron and unavoidable impurities the soft magnetic alloy consists of 2 wt %≤Si+Al≤4 wt %, wt %≤Mn+C+S+Se+N+Ti+P+As+Sn+Sb+Te+Bi+Cu+Ni+Mo+Cr+Co+B+V+Nb+O≤1 wt %.

20. A method according to claim 1, wherein in addition to iron and unavoidable impurities the soft magnetic alloy consists of 4 wt %≤Si+Al≤8 wt % and 0 wt %≤Mn+C+S+Se+N+Ti+P+As+Sn+Sb+Te+Bi+Cu+Ni+Cr+Co+B+V+Nb+N+O≤1.0.

21. A method according to claim 1, wherein the soft magnetic alloy consists of 5 wt % to 12 wt % Si, 2 wt % to 10 wt % Al, up to 0.5 wt % of impurities and the balance Fe.

22. A method according to claim 1, wherein the soft magnetic alloy consists of 5 wt % to 30 wt % Co, 0 wt %≤V+Cr+Si+Mn+Al+Ta+Ni+Mo+Cu+Nb+Ti+Zr≤10 wt %, up to 0.2 wt % impurities and the balance Fe.

23. A method according to claim 1, wherein the soft magnetic alloy consists of 30 wt % to 55 wt % Co, 0 wt %≤V+Cr+Si+Mn+Al+Ta+Ni+Mo+Cu+Nb+Ti+Zr≤5 wt %, up to 0.2 wt % impurities and the balance Fe.

24. A method according to claim 1, wherein the soft magnetic alloy is an iron-aluminium alloy.

25. A method according to claim 24, wherein the iron-aluminium alloy consists of 5 wt % to 20 wt % Al, 0≤Mn+C+S+Se+N+Ti+P+As+Sn+Sb+Te+Bi+Cu+Ni+Cr+Co+B+V+Nb+N+O+Si≤3 wt %, up to 0.2 wt % impurities and the balance Fe.

26. A method according to claim 1, wherein the soft magnetic alloy is an iron-cobalt-aluminium alloy.

27. A method according to claim 26, wherein the iron-cobalt-aluminium alloy consists of 5 wt % to 60 wt % Co, 0.5 wt % to 5 wt % Al, 0≤Mn+C+S+Se+N+Ti+P+As+Sn+Sb+Te+Bi+Cu+Ni+Cr+Co+B+V+Nb+N+O+Si≤3 wt %, up to 0.2 wt % impurities and the balance Fe.

28. A method according to claim 1, wherein the part has the form of a yoke for relay applications or an armature for relay applications, of a flux conductor, of a part for electromagnetic lenses, of an armature for injection technology or of a cup system for injection technology, of a part for electromagnetic actuators, of a part for a sensor system, of a part for a torque sensor, of a lamination for stators and rotors of motors, generators or other electric machines.

29. A method according to claim 1, the powder having an average particle size of 10 μm to 80 μm.

30. A method according to claim 1, the part being built up layer by layer by repeating the following steps:
applying a layer made of the powder, and
selectively melting the layer using a three-dimensionally controllable energy beam according to a three-dimensional CAD file of the part in order to produce a layer of the part.

31. A method according to claim 1, the part having a crystalline structure.
